(19) United States
(12) Patent Application Publication
(10) Pub. No.: US 2016/0048249 A1
(43) Pub. Date: Feb. 18, 2016

(54) WEARABLE COMPUTING DEVICE FOR HANDSFREE CONTROLLING OF VEHICLE COMPONENTS AND METHOD THEREFOR

(71) Applicant: Honda Motor Co., Ltd., Tokyo (JP)

(72) Inventors: SIYUAN CHEN, MOUNTAIN VIEW, CA (US); GOKULA KRISHNAN, SAN JOSE, CA (US); FUMINOBU KUROSAWA, SAN JOSE, CA (US); YOSHIYUKI HABASHIMA, REDONDO BEACH, CA (US); MASAYUKI SATO, SAN MATEO, CA (US); ARTHUR ALANIZ, CUPERTINO, CA (US); MICHAEL EAMONN GLEESON-MAY, SAN FRANCISCO, CA (US)

(21) Appl. No.: 14/459,741

(22) Filed: Aug. 14, 2014

(51) Int. Cl. G06F 3/048; E05F 15/77

(52) U.S. Cl. CPC G06F 3/048; E05F 15/77

(57) ABSTRACT

A system and method of remotely controlling a component of a vehicle using a wearable computing device comprising: viewing an identifying characteristic on the vehicle by the wearable computing device; comparing the identifying characteristic viewed to an identifying characteristic image stored in a memory of the wearable computing device; and sending a command signal from the wearable computing device to the vehicle to control the component when the identifying characteristic viewed corresponds to the identifying characteristic image stored in the memory.

### TECHNICAL FIELD

The present application relates generally to hands free vehicle control, and more specifically, to a wearable computing device that allows one to control predetermined vehicle functions and or components hands free.

### BACKGROUND

Vehicle manufactures have developed radio transmitting devices called key fobs to control certain functions and or components of a vehicle. A key fob is a remote signaling device that may be used to control a number of different systems on a vehicle typically with a radio frequency (RF) signal. Key fobs may be used to arm and disarm a security system of the vehicle, remotely open a trunk of a vehicle, and lock and unlock front and or rear doors of the vehicle. Key fobs may perform these functions by pressing different buttons and or combination of buttons located on the key fob device.

One issue with the use of key fobs is that the user has to press one or more buttons to control certain functions and or components of the vehicle. Thus, it may be inconvenient for a driver carrying packages, such as groceries, to press a button on the key fob to unlock the vehicle door, open the trunk of the vehicle, and the like. Another problem with the use of the key fob is that the buttons on the key fob may be accidently pressed. For example, when reaching for an item in a driver's pocket or in a driver's purse, the driver may inadvertently press a button on the key fob. By inadvertently pressing a button, the driver may unknowing unlock the vehicle's doors, open the trunk of the vehicle, or the like.

Therefore, it would be desirable to provide a device and method that overcomes, at least in part, the above described issues.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one embodiment, a method of remotely controlling a component of a vehicle through a wearable computing device comprises: viewing an identifying characteristic on the vehicle by the wearable computing device; comparing the identifying characteristic viewed to an identifying characteristic image stored in a memory of the wearable computing device; and sending a command signal from the wearable computing device to the vehicle to control the component when the identifying characteristic viewed corresponds to the identifying characteristic image stored in the memory.

In accordance with one embodiment, a method of remotely controlling a component of a vehicle through a wearable computing device comprises: linking the wearable computing device to the vehicle; viewing an identifying characteristic on the vehicle by the wearable computing device; comparing the identifying characteristic viewed to an identifying characteristic image stored in a memory of the wearable computing device; viewing the component on the vehicle by the wearable computing device; comparing the component viewed to a component image stored in the memory; and sending a command signal from the wearable computing device to the vehicle to control the component when the identifying characteristic viewed corresponds to the identifying characteristic image stored in the memory component and when the component viewed corresponds to the component image stored in the memory.

In accordance with another embodiment, a wearable computing device for remote control of a component of a vehicle has a viewer. A processor is coupled to the viewer. A memory is coupled to the processor. The memory stores program instructions that when executed by the processor, causes the processor to: link the wearable computing device to the vehicle; compare an identifying characteristic seen through the viewer to an identifying characteristic image stored in the memory; compare the component seen through the viewer to a component image stored in the memory; and send a command signal to control the component when the identifying characteristic seen through the viewer corresponds to the identifying mark image stored in the memory and when the component seen through the viewer corresponds to the component image stored in the memory.

### BRIEF DESCRIPTION OF DRAWINGS

Embodiments of the disclosure will become more fully understood from the detailed description and the accompanying drawings, wherein:

FIG. 1 is a perspective view of a vehicle implementing an exemplary system for hands free controlling of certain vehicle functions in accordance with one aspect of the present application;

FIG. 2 is a perspective view showing a person using an illustrative wearable device for hands free controlling of certain vehicle functions in accordance with one aspect of the present application;

FIG. 3 shows a simplified functional block diagram showing an illustrative Electronic Control Unit (ECU) of the vehicle depicted in FIGS. 1-2 for allowing hands free controlling of certain vehicle functions in accordance with one aspect of the present application;

FIG. 4 shows a simplified functional block diagram showing an exemplary embodiment of a wearable device for hands free controlling of certain vehicle functions in accordance with one aspect of the present application; and

FIG. 5 shows a simplified flowchart of an exemplary method for hands free controlling of certain vehicle functions in accordance with one aspect of the present application;

FIG. 6 is a perspective view showing a person using an illustrative wearable device for hands free controlling of certain vehicle functions in accordance with one aspect of the present application;

FIG. 7A is a perspective view showing a person using an illustrative wearable device for hands free controlling of certain vehicle functions in accordance with one aspect of the present application; and

FIG. 7B is a perspective view showing a person using an illustrative wearable device for hands free controlling of certain vehicle functions in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

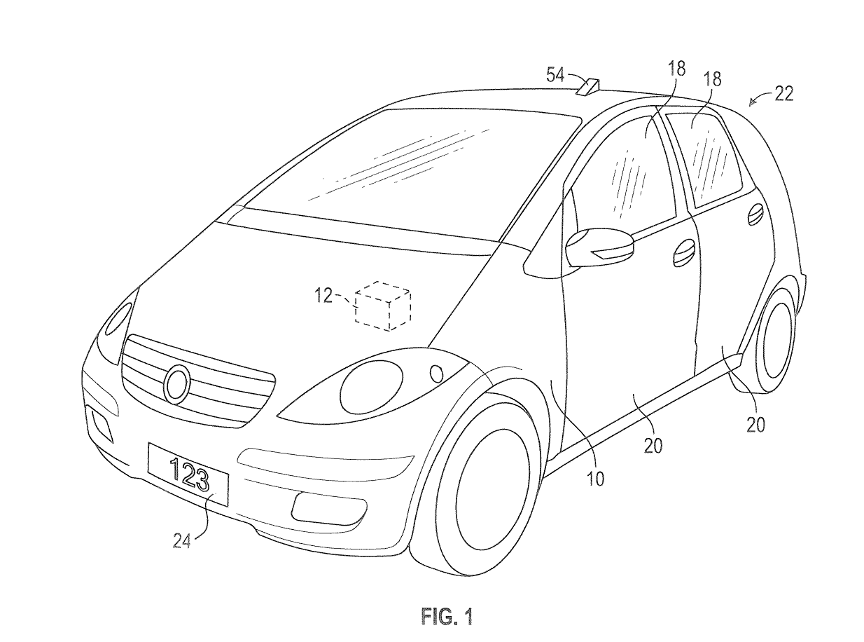

Referring to FIGS. 1-4, a system for hand free remote control of a vehicle 10 will be disclosed. The vehicle 10 may be equipped with an Electronic Control Unit (ECU) 12. The ECU 12 may be coupled to a plurality of different vehicle control system 14. The ECU 12 may allow a user to control one or more of the plurality of different vehicle control systems 14 within the vehicle 10 via switches located within the vehicle 10 and or remotely through the use of a remote control device 16. For example, the ECU 12 may be coupled to a window control system 14A, a door lock control system 14B, a trunk control system 14C, and a vehicle ignition start 14D. The above is given as examples and should not be seen in a limiting manner. The vehicle 10 may have other vehicle control systems 14 coupled to and controlled through the use of the ECU 12.

The ECU 12 may be coupled to the window control system 14A. The window control system 14A may allow a user to open and close the windows 18 of the vehicle 10 either through control switches in the vehicle 10 or remotely via the remote control device 16. The ECU 12 may be coupled to the door lock system 14B. The door lock control system 14B may allow a user to lock and unlock the doors 20 of the vehicle 10 either through control switches in the vehicle 10 or remotely via the remote control device 16. The ECU 12 may be coupled to the trunk control system 14C. The trunk control system 14C may allow a user to open the trunk 22 of the vehicle 10 and in some embodiments open and close the trunk 22 of the vehicle 10 either through control switches in the vehicle 10 or remotely via the remote control device 16. The ECU 12 may be coupled to the vehicle ignition start 14D. The vehicle ignition start 14D may allow a user to start the vehicle 10 either through the use of a key, a paring of a key fob and a push button control in the vehicle 10 or remotely via the remote control device 16.

The ECU 12 may be coupled to a wireless communication interface 50. The wireless communication interface 50 may allow the vehicle 10 to wirelessly communicate with a server network 30 and or a remote control device 16. The wireless communication interface 50 may use a variety of forms of wireless communication that may support bi-directional data exchange when communicating with the server network 30. For example, the wireless communication interface 50 may use 3G cellular communications, such as CDMA, EVDO, GSM/GPRS, or 4G cellular communications, such as WiMAX or LTE or the like. Alternatively, the wireless communication interface 32 may communicate with the server network 30 via a wireless local area network (WLAN), for example, using Wi-Fi or the like.

The wireless communication interface 50 may be configured to communicate with the remote control device 16. The wireless communication interface 50 may communicate directly with the remote control device 16 using an infrared link, Bluetooth, or Near Field Communication (NFC). The above is given as an example and should not be seen in a limiting manner as other wireless technology standards for exchanging data may be used. Alternatively, the wireless communication interface 50 may be configured to communicate with the remote control device 16 indirectly, such as through a WLAN using Wi-Fi. The wireless communications may be uni-directional or bi-directional.

The ECU 12 may execute program instructions that may be stored in a non-transitory computer readable medium, such as data storage 52. Thus, the ECU 12, in combination with instructions stored in data storage 52, may function as a controller of the vehicle 10. The ECU 12 may be coupled to the plurality of different vehicle control systems 14 which may be remotely controlled. The ECU 12 may be used to send signals to the different vehicle control systems 14. The ECU 12 may be used to translate signals received by the wireless communication interface 50 and to send signals to control the different vehicle control systems 14 based on signals received by the wireless communication interface 50.

The vehicle 10 may have a Global Position System (GPS) receiver 54. The GPS receiver 54 may be used to determine the location of the vehicle 10. The location of the vehicle 10 may be used in operation of the remote control device 16 when remotely controlling the different vehicle control systems 14 of the vehicle 10 as will be disclosed below.

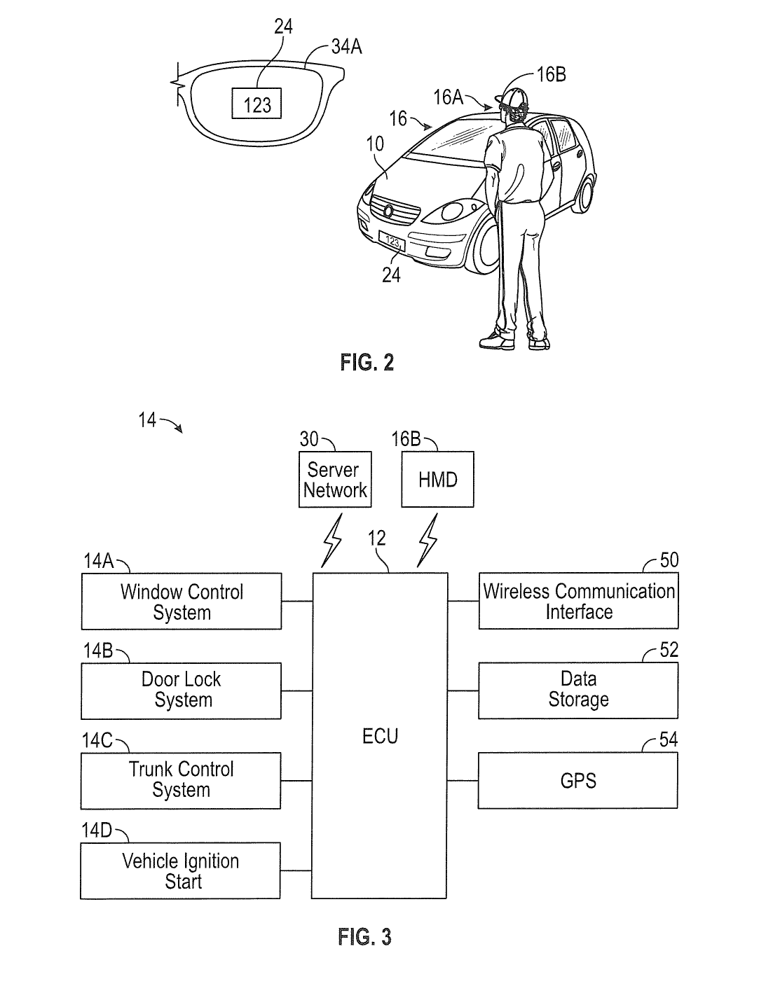

The vehicle control systems 14 may be controlled through the remote control device 16. In the embodiment shown in FIG. 2, the remote control device 16 is a wearable device 16A. The wearable device 16A may allow a user to control the different vehicle control systems 14 remotely. The wearable device 16A may be a head mounted display (HMD) device 16B. The HMD device 16B may allow a user to control the different vehicle control systems 14 remotely and hands free. The HMD device 16B may allow a user to control the different vehicle control systems 14 in different manners. For example, the HMD device 16B may allow a user to control the different vehicle control systems 14 by using gestures that may be detected, translated, and wirelessly transmitted by the HMD device 16B to the vehicle 10 for controlling the different vehicle control systems 14. The HMD device 16B may have one or more input buttons which may be pressed to allow a user to control the different vehicle control systems 14. The HMD device 16B may have other input mechanisms as well which may be used to allow a user to control the different vehicle control systems 14 then those described above.

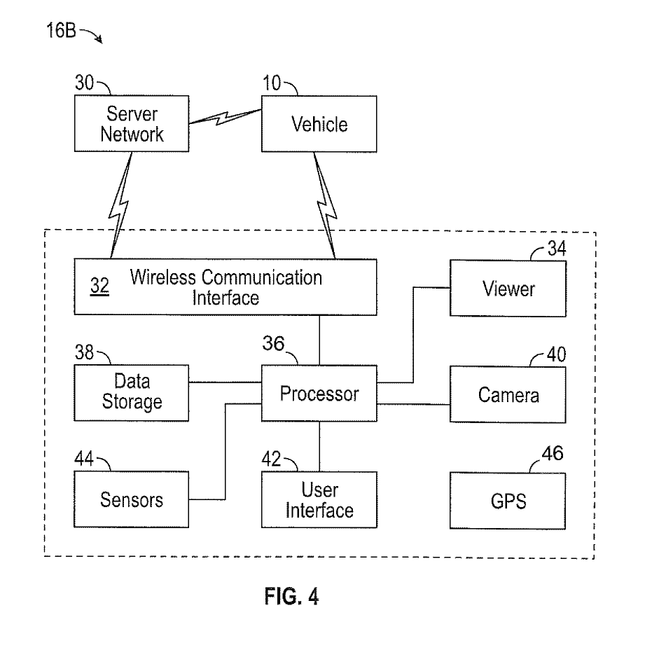

Referring now to FIG. 4, one embodiment of the HMD device 16B may be seen. The HMD device 16B may be able to communicate with the server network 30 as well as the vehicle 10. The server network 30 may be a Local Area Network (LAN), Wireless Local Area Network (WLAN), Wide Area Network (WAN), or the like. The listing is given as an example and should not be seen in a limiting manner.

The HMD device 16B may have a wireless communication interface 32. The wireless communication interface 32 may allow the HMD device 16B to wirelessly communicate with the server network 30 and or the vehicle 10. The wireless communication interface 32 may use various forms of wireless communication that can support bi-directional data exchange when communicating with the server network 30. For example, the wireless communication interface 32 may use 3G cellular communications, such as CDMA, EVDO, GSM/GPRS, or 4G cellular communications, such as WiMAX or LTE. Alternatively, the wireless communication interface 32 may communicate with the server network 30 via a wireless local area network (WLAN), for example, using Wi-Fi or the like.

Wireless communication interface 32 may be configured to communicate with the vehicle 10. The wireless communication interface 32 may communicate directly with the vehicle 10 using an infrared link, Bluetooth, or NFC. Other wireless technology standards for exchanging data may be used in the present application as well. The wireless communication interface 32 may be configured to communicate with the vehicle 10 indirectly, such as through a WLAN using Wi-Fi. The wireless communications may be uni-directional, for example, with HMD device 16B transmitting one or more control instructions to the vehicle 10. Alternatively, the wireless communications could be bi-directional, so that vehicle 10 may communicate status information in addition to receiving control instructions.

The HMD device 16B may have a viewer 34. The viewer 34 may function as a viewfinder for the HMD device 16B. The viewer 34 may further function as a display. In accordance with one embodiment, the viewer 34 may be a see-through display 34A (hereinafter display 34A) which may function as both a viewfinder and a display. The display 34A may be operable to display images that are superimposed on the field of view. The HMD device 16B may be controlled by a processor 36. The processor 36 may execute program instructions that may be stored in a non-transitory computer readable medium, such as data storage 38. Thus, the processor 36 in combination with instructions stored in data storage 38 may function as a controller of the HMD device 16B. In addition to the program instructions that may be stored in the data storage 38, the data storage 38 may store data that may facilitate interactions with the vehicle 10. For example, the data storage 38 may function as a database for storing information and images related to the vehicle 10 as will be disclosed below.

The HMD device 16B may have a camera 40. The camera 40 may be used to capture images being viewed through display 34A. The images may be still images, video images, or both. The images captured may be stored in the data storage 38.

The HMD device 16B may also include a user interface 42. The user interface may be used for receiving inputs from the wearer of the HMD 16B. The user interface 42 may be buttons, a touchpad, a keypad, a microphone, and/or other input devices. The processor 36 may control the functioning of the HMD device 16B based on inputs received through user interface 42. The HMD device 16B may have one or more sensors 44. The sensors 44 may be used for detecting movement of the HMD device 16B. The sensors 44 may include motion sensors, such as accelerometers and/or gyroscopes. The sensors 44 may be used for detecting gestures by the user. When the sensors 44 detect certain movements, the processor 36 may interpret these movements as inputs for control the functioning of the HMD device 16B. Sensors 44 may be used for determining when the HMD device 16B is within a predetermined proximity of vehicle 10. When the sensors 44 determine that the HMD device 16B is within a predetermined proximity of vehicle 10, the HMD device 16B may be enabled to remotely control the vehicle 10.

The HMD device 16B may have a Global Position System (GPS) receiver 46. The GPS receiver 46 may be used to determine the location of the HMD device 16B. The HMD device 16B may then compare the location of the HMD device 16B to the last known location of the vehicle 10 as will be disclosed below.

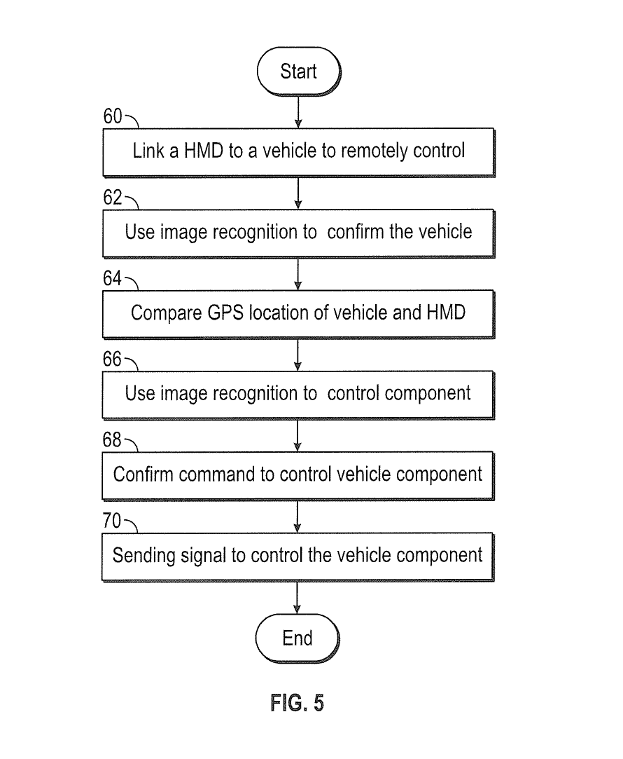

Referring to FIG. 5, the HMD device 16B may be programmed to use image recognition for controlling the different vehicle control systems 14 of the vehicle 10. The HMD device 16B may be programmed to use image recognition, and gestures or other inputs to send signals to the vehicle 10 to remotely control the different vehicle control systems 14. As shown in block 60, the HMD 16B may be linked to the vehicle 10. Linking may associate the HMD device 16B to a specific vehicle 10 and may connect the HMD device 16B to the specific vehicle 10 to form a trusted communication pathway so the HMD device 16B may send command signals to control the different vehicle control systems 14 in the specific vehicle 10.

The HMD device 16B may be linked to a specific vehicle 10 by using the camera 40 associated with the HMD device 16B. The user may take an image of a unique identifying characteristic or mark (hereinafter identifying mark) associated with the specific vehicle 10 using the camera 40. The image of the unique identifying mark may be stored in the data storage 38. The unique identifying mark may be a license plate 24 associated with the specific vehicle 10, a Vehicle Identification Number (VIN), or other unique identifying marks and or characteristics that may be associated with the specific vehicle 10. Alternatively, the user may use the user interface 42 to enter information on the unique identifying mark associated with the specific vehicle 10, which would then be stored in the data storage 38. For example, the user may use the user interface 42 to enter the alpha-numeric license plate number into the HMD device 16B.

The HMD device 16B may be paired with the specific vehicle 10. In accordance with one embodiment, Bluetooth pairing may be used to link the HMD device 16B with the vehicle 10. Bluetooth pairing may be triggered automatically the first time the vehicle 10 receives a connection request from the HMD device 16B or vice versa with which it is not yet paired. Once the Bluetooth pairing has been established it is remembered by the devices, which can then connect to each without user intervention. By pairing the HMD device 16B to the specific vehicle 10, the HMD device 16B may send coded signals to the specific vehicle 10. The coded signals may be recognized by the ECU 12 of the vehicle 10 as being associated with the HMD device 16B linking the HMD device 16B with the vehicle 10. Once the HMD device 16B has been linked with the specific vehicle 10, the HMD device 16B may be used to control the different vehicle control systems 14 of the vehicle 10.

In block 62, the processor 36 may execute image recognition program instructions to confirm that the HMD device 16B may be used to control the different vehicle control systems 14. When a user of the HMD device 16B approaches the vehicle 10, the user may look through the see through display 34A of the HMD device 16B. The user may focus on the unique identifying mark on the vehicle 10 (See FIG. 2). What is being viewed through the see-through display 34A may be captured by the camera 40 associated with the HMD device 16B. The processor 36 may compare the image of the unique identifying mark associated with the specific vehicle 10 to that which is currently being viewed through the see-through display 34A. If the image of the unique identifying mark stored in the data storage 38 matches that which is currently being viewed through the see-through display 34A, the HMD device 16B may be used to control the different vehicle control systems 12. If the image of the unique identifying mark stored in the data storage 38 does not matches that which is currently being viewed through the see-through display 34A, the HMD device 16B may not be used to control the different systems 12 remotely and hands free.

In block 64, to prevent false positives, the HMD device 16B may compare the current GPS coordinates of the HMD device 16B to the GPS coordinates of the vehicle 10. If the HMD device 16B determines that the HMD device 16B is within a predefined distance from the last known location of the vehicle 10, the HMD device 16B may be used to control the different vehicle control systems 12. If the HMD device 16B determines that the HMD device 16B is not within a predefined distance from the last known location of the vehicle 10, the HMD device 16B may not be used to control the different systems 12.

The location of the vehicle 10 and the HMD device 16B may be determined in different manners. For example, when the vehicle 10 stops, the current location of the vehicle 10 as determined by the GPS receiver 56 of the vehicle 10 may be transmitted to the HMD device 16B. The current location of the vehicle 10 may be stored in data storage 38 of the HMD device 16B. When a user tries to use the HMD device 16B to control one or more of the vehicle control systems 12 of the vehicle 10, the HMD device 16B may be programmed to compare the current location of the HMD device 16B as indicated by the GPS receiver 46 to the last known location of the vehicle 10 stored in the data storage 38.

Alternatively, if either the vehicle 10 and or the HMD device 16B do not have a GPS receiver, the location of the vehicle 10 and or the HMD 16B may be determined by a cellular phone which may be linked to the vehicle 10 and or the HMD device 16B. For example, when the vehicle 10 stops, the cellular phone may transmit the current location of the vehicle 10 as determined by the cellular phone to the HMD device 16B. If the HMD device 16B does not have a GPS receiver, when a user tries to use the HMD device 16B to control one or more vehicle control systems 14 of the vehicle 10, the HMD device 16B may be programmed to compare the current location of the cellular phone and sent to the HMD device 16B to the last known location of the vehicle 10 stored in the data storage 38.

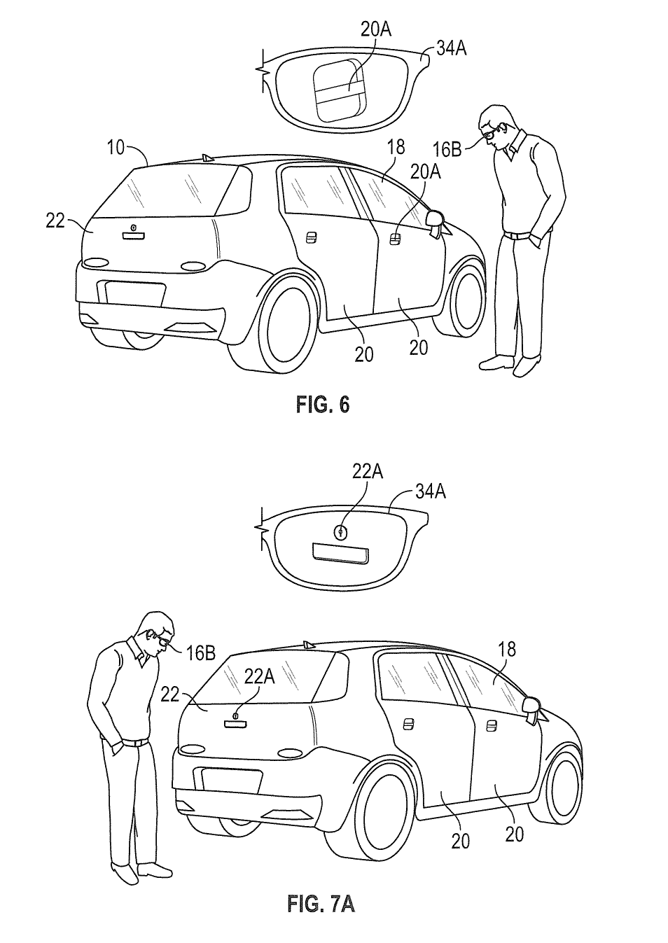

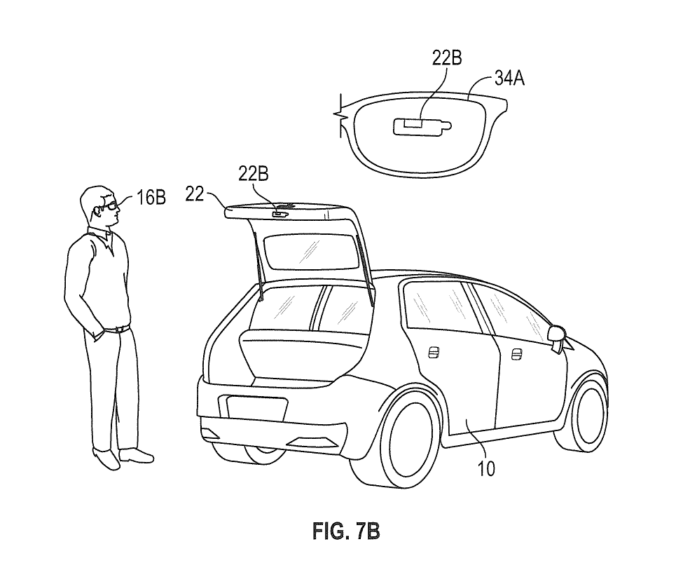

In block 66, once the HMD device 16B and the vehicle 10 have been linked, the HMD device 16B may be used to control different vehicle control systems 14. The HMD device 16B may control the different vehicle control systems 14 in different manners. In accordance with one embodiment, the HMD device 16B may use image recognition to control the different vehicle control systems 14. The user may look through the see through display 34A of the HMD device 16B. The user may focus on a specific component of the vehicle 10 the user may wish to control. For example, if the user would like to open the trunk 22, the user may look through the see through display 34A of the HMD device 16B at the trunk 22 of the vehicle 10 as shown in FIG. 7A. If the user would like to close the trunk 22, the user may look through the see through display 34A of the HMD device 16B at the trunk 22 of the vehicle 10 as shown in FIG. 7B. If the user would like to lock and or unlock the doors 20, the user may look through the see through display 34A of the HMD device 16B at one of the doors 20 of the vehicle 10 as shown in FIG. 6. If the user would like to open or close a window 18, the user may look through the see through display 34A of the HMD device 16B at one of the windows 18 of the vehicle 10. The HMD device 16B may be programmed to individually control specific doors 20 and or windows 18. In this embodiment, the user may look through the see through display 34A of the HMD 14C at a specific door 20 and or window 18 the user would like to remotely control.

In accordance with another embodiment, the HMD 16B may be programmed to associate a particular function with a particular image. Thus, when the user loads an image into the HMD 16B, a particular function may be associated with that specific image. For example, when an image of the license plate 24 is loaded into the HMD 16B, the HMD 16B may be programmed to unlock the doors 20, open the trunk 22, start the vehicle 10, or control another system 14 of the vehicle 10. In this embodiment, when the user looks through the see through display 34A of the HMD device 16B and sees the license plate 24, the processor 36 may compare the image of the license plate 24 to that which is currently being viewed through the see-through display 34A. If the image of the license plate 24 stored in the data storage 38 matches that which is currently being viewed through the see-through display 34A, the HMD device 16B may send a control signal to unlock the doors 20, open the trunk 22, start the vehicle 10, or control another system 14 of the vehicle 10.

To prevent false positives, the user may have to focus on a specific area of a specific component of the vehicle 10 the user may wish to control. For example, if the user would like to open a specific door 20, the user may look through the see through display 34A of the HMD device 16B at a specific handle 20A of the door 20 the user wishes to lock and or unlock. Similarly, if the user would like to open the trunk 22 of the vehicle 10, the user may look through the see through display 34A of the HMD 16B at a key lock 22A of the trunk 22 or a vehicle emblem located on the trunk 22. The user may close the trunk 22 of the vehicle 10, in a similar manner by looking through the see through display 34A of the HMD 16B at a trunk closure button 22B (See FIG. 7B). The above is given as an example and should not be seen in a limiting manner.

In block 68, the user may send control signals to the specific component of the vehicle 10 the user may wish to control. The user may send control signals by using the user interface 42. By pressing different buttons or other input devices on the user interface 42, the user may control the specific component of the vehicle 10 the user is currently looking at through the see through display 34A of the HMD device 16B. Alternatively, the user may use gestures to control the specific component of the vehicle 10 the user is currently looking at through the see through display 34A of the HMD device 16B. The processor 36 of the HMD device 16B may interpret these movements as inputs for controlling the specific component of the vehicle 10 the user is currently looking at through the see through display 34A of the HMD 14C. For example, the user may move his head in a downward motion to lock the door 20 or in an upward motion to unlock the door 20. Similarly, the user may move his head in a downward motion to lower the window 18 or in an upward motion to close the window 18. The above is given as examples as other gestures may be used.

In block 70, the HMD device 16B may ask for a confirmation of the command to control the specific component. The HMD device 16B may ask for a confirmation in different manners. For example, the HMD device 16B may send a written message which may be viewable on the see through display 34A asking to confirm the command. The HMD 16B may send an audible message to confirm the command. The HMD 16B may send some sensor message such as vibrating or a blinking light to confirm the command.

The user of the HMD device 16B may verify the command in different manners. For example, the user may press one or more buttons or other input devices on the user interface 42. Alternatively, the user may use gestures to confirm the command. When using gestures, the user may simply nod his head “Yes” to confirm or “No” to cancel. The processor 36 of the HMD device 16B may interpret these movements as inputs for confirming the command to control the specific component of the vehicle 10 the user is currently looking at through the see through display 34A of the HMD 16B. The above is given as examples as other gestures may be used to confirm the command.

In block 72, once the command has been confirmed, the HMD device 16B may send a signal to control the specific component of the vehicle 10 the user is currently looking at through the see through display 34A of the HMD device 16B.

The HMD device 16B may perform multiple command functions. For example, the user may use the HMD device 16B to open the truck 22 and then close the trunk 22. If the user would like to open the trunk 22 of the vehicle, the user may look through the see through display 34A of the HMD device 16B at the trunk 22 of the vehicle 10 as shown in FIG. 7A or at the license plate 24 if the image of the license plate 24 is associated with opening the trunk 22. Once the command to open the trunk 22 has been confirmed, the HMD device 16B may send a control signal to open the trunk 22. If the trunk 22 no longer needs to be open, the user may then close the trunk 22 using the HMD device 16B. The user may look through the see through display 34A of the HMD device 16B at the trunk closure button 22B of the vehicle 10 as shown in FIG. 7B. Once the command to close the trunk 22 has been confirmed, the HMD device 16B may send a control signal to close the trunk 22. The above example may be naturally extended to the other components of the vehicle 10.

The HMD device 16B may be programmed to use image recognition for hands free controlling of different components of the vehicle 10. By recognizing an identifying characteristic and or component of the vehicle 10 that the user is looking at through the HMD device 16B, the HMD device 16B may provide the corresponding control access to the user. Thus, by recognizing the license plate of the vehicle 10, and or the trunk 22 of the vehicle 10, remote hands free opening/closing functions of the trunk 22 may be realized. The concept/function may be naturally extended to control other components of the vehicle 10.

While embodiments of the disclosure have been described in terms of various specific embodiments, those skilled in the art will recognize that the embodiments of the disclosure may be practiced with modifications within the spirit and scope of the claims

1. A method of remotely controlling a component of a vehicle through a wearable computing device, the method comprising:
viewing an identifying characteristic on the component of the vehicle by the wearable computing device;
comparing the identifying characteristic viewed to an identifying characteristic image stored in a memory of the wearable computing device, wherein the identifying characteristic image is associated with at least one function of the component;
sending a command signal from the wearable computing device to the vehicle to control the at least one function of the component when the identifying characteristic on the component being viewed corresponds to the identifying characteristic image stored in the memory; and
confirming the sending of the control signal to the component by: receiving by the wearable computing device, an image of a selected area indicating a control portion of the component, determining a control function of the component based on the received image of the selected area, and configuring the command signal based on the determined control function of the component.

2. The method of claim 1, further comprising:
storing the identifying characteristic image in the memory; and
associating the identifying characteristic image to the component to be controlled.

3. (canceled)

4. The method of claim 1, wherein sending the command signal to control the at least one function of the component comprises:
sensing a gesture made by a user by the wearable computing device; and
translating the gesture to the command signal corresponding to the at least one function of the component.

5. The method of claim 1, further comprising linking the wearable computing device to the vehicle.

6. The method of claim 5, wherein the wearable computing device is paired to the vehicle.

7. The method of claim 1, further comprising comparing a current location of the wearable computing device to a last known location of the vehicle.

8. The method of claim 7, wherein comparing the current location of the wearable computing device to the last known location of the vehicle comprises:
loading the last known location of the vehicle to the memory of the wearable computing device; and
calculating the current location of the wearable computing device;
wherein the wearable computing device sends the command signal to control the component if the last known location of the vehicle is within a predetermined distance from the current location of the wearable computing device.

9. (canceled)

10. The method of claim 1, wherein confirming the sending of the control signal to the component further comprises:
sensing a confirmation gesture by the user by the wearable computing device; and
translating the confirmation gesture to the command signal.

11. A method of remotely controlling a component of a vehicle through a wearable computing device, the method comprising:
linking the wearable computing device to the vehicle;
viewing an identifying characteristic on the vehicle by the wearable computing device;
comparing the identifying characteristic viewed to an identifying characteristic image stored in a memory of the wearable computing device, wherein the identifying characteristic image is associated with at least one function of the component;
viewing the component on the vehicle by the wearable computing device;
comparing the component viewed to a component image stored in the memory;
sending a command signal from the wearable computing device to the vehicle to control the at least one function of the component when the identifying characteristic viewed corresponds to the identifying characteristic image stored in the memory component and when the component viewed corresponds to the component image stored in the memory; and
confirming the sending of the control signal to the component by: receiving by the wearable computing device, an image of a selected area indicating a control portion of the component, determining a control function of the component based on the received image of the selected area, and configuring the command signal based on the determined control function of the component.

12. The method of claim 11, wherein sending the command signal to control the at least one function of the component comprises:
sensing a gesture made by a user of the wearable computing device; and
translating the gesture to the command signal corresponding to the at least one function of the component.

13. The method of claim 11, further comprising comparing a current location of the wearable computing device to a last known location of the vehicle.

14. The method of claim 13, wherein comparing the current location of the wearable computing device to the last known location of the vehicle comprises:
loading the last known location of the vehicle to the memory of the wearable computing device; and
calculating the current location of the wearable computing device;
wherein the wearable computing device sends the command signal to control the component if the last known location of the vehicle is within a predetermined distance from the current location of the wearable computing device.

15. (canceled)

16. The method of claim 11, wherein confirming the sending of the control signal to the component further comprises:
sensing a confirmation gesture by the user of the wearable computing device; and
translating the confirmation gesture to the command signal.

17. A wearable computing device for remote control of a component of a vehicle, comprising:
a viewer;
a processor coupled to the viewer; and
a memory coupled to the processor, the memory storing program instructions that when executed by the processor, causes the processor to:
link the wearable computing device to the vehicle;
compare an identifying characteristic seen through the viewer to an identifying characteristic image stored in the memory, wherein the identifying characteristic image is associated with at least one function of the component;
compare the component seen through the viewer to a component image stored in the memory;
send a command signal to control the at least one function of the component when the identifying characteristic seen through the viewer corresponds to the identifying mark image stored in the memory and when the component seen through the viewer corresponds to the component image stored in the memory; and
confirm the sending of the control signal to the component by: receiving by the wearable computing device, an image of a selected area indicating a control portion of the component, determining a control function of the component based on the received image of the selected area, and configuring the command signal based on the determined control function of the component.

18. The wearable computing device of claim 17, wherein sending the command signal to control the at least one function of the component comprises:
sensing a gesture by a user by the wearable computing device; and
translating the gesture to the command signal corresponding to the at least one function of the component.

19. The wearable computing device of claim 17, wherein the program instructions executed by the processor, causes the processor to:
load a last known location of the vehicle to the memory of the wearable computing device; and
calculate a current location of the wearable computing device;
wherein the wearable computing device sends the command signal to control the component if the last known location of the vehicle is within a predetermined distance from the current location of the wearable computing device.

20. (canceled)
